(19) United States
(12) Patent Application Publication
(10) Pub. No.: US 2014/0109156 A1
(43) Pub. Date: Apr. 17, 2014

(54) METHOD, TERMINAL, SERVER AND SYSTEM FOR PLAYING MEDIA FILE

(71) Applicant: HUAWEI TECHNOLOGIES CO., LTD., Shenzhen (CN)

(72) Inventor: Yu ZHANG, Beijing (CN)

(73) Assignee: HUAWEI TECHNOLOGIES CO., LTD., Shenzhen (CN)

(21) Appl. No.: 14/136,244

(22) Filed: Dec. 20, 2013

Related U.S. Application Data
(63) Continuation of application No. PCT/CN2011/082295, filed on Nov. 16, 2011.

(51) Int. Cl. H04N 21/6587; H04N 21/845; H04N 21/643

(52) U.S. Cl. CPC H04N 21/6587; H04N 21/64322; H04N 21/8456
USPC 725/90

(57) ABSTRACT

A method, a terminal, a server, and a system play a media file. The method includes: obtaining a fast play state of a media file that is based on the HLS protocol; determining intra-coded frame information corresponding to the fast play state; sending a request message to a server, where the request message includes the intra-coded frame information; receiving a response message, which is sent by the server according to the request message, where the response message includes intra-coded frame data corresponding to the intra-coded frame information; and playing the intra-coded frame data according to the response message. According to the present invention, i a terminal supporting HLS can obtain the intra-coded frame data corresponding to a fast play state of the media file and play the data.

### CROSS-REFERENCE TO RELATED APPLICATIONS

This application is a continuation of International Application No. PCT/CN2011/082295, filed on Nov. 16, 2011, which is hereby incorporated by reference in its entirety.

### TECHNICAL FIELD

Embodiments of the present invention relate to the field of information technologies, and in particular, to a method, a terminal, a server, and a system for playing a media file in the field of information technologies.

### BACKGROUND

A most typical technology in conventional video playing technologies based on the Hyper Text Transfer Protocol (Hyper Text Transfer Protocol, “HTTP” for short) is an HTTP progressive download technology. In the HTTP progressive download technology, each video content corresponds to a video file of only one code rate. When client-side bandwidth is low or when bandwidth changes at a high frequency, a short pause occurs during playing of a player, which deteriorates user experience in watching the video.

When an adaptive streaming (Adaptive Streaming) technology is used, the player may obtain audio and video fragments of different code rates from a server according to factors such as available bandwidth of the player, a load of a central processing unit (Central Processing Unit, “CPU” for short), and a screen size. In this way, the entire procedure of video playing is smoother.

In multiple current adaptive streaming technologies, the Hyper Text Transfer Protocol Live Streaming (HTTP Live Streaming, “HLS” for short) protocol put forward by the Apple (Apple) Incorporation is the most prevalent. However, compared with other protocols, the HLS protocol has obvious disadvantages in functionality. That is to say, the HLS protocol does not support fast-forward or rewind. Consequently, all terminals supporting HLS that are currently available in the market do not provide the fast-forward or rewind function, which affects the quality of user experience seriously.

Therefore, a technical solution is demanded to enable a terminal supporting HLS to implement the fast-forward or rewind function.

### SUMMARY

Embodiments of the present invention provide a method, a terminal, a server, and a system for playing a media file, which can enable a terminal supporting HLS to implement a fast-forward or rewind function and improve the quality of user experience.

In one aspect, an embodiment of the present invention provides a method for playing a media file, where the method includes: obtaining a fast play state of a media file that is based on the Hyper Text Transfer Protocol Live Streaming HLS protocol; determining intra-coded frame information corresponding to the fast play state; sending a request message to a server, where the request message includes the intra-coded frame information; receiving a response message, which is sent by the server according to the request message, where the response message includes intra-coded frame data corresponding to the intra-coded frame information; and playing the intra-coded frame data according to the response message.

In another aspect, an embodiment of the present invention provides a method for playing a media file, where the method includes: receiving from a terminal a request message that includes intra-coded frame information, where the intra-coded frame information corresponds to a fast play state, which is obtained by the terminal, of a media file that is based on the Hyper Text Transfer Protocol Live Streaming HLS protocol; obtaining intra-coded frame data corresponding to the intra-coded frame information according to the request message; and sending to the terminal a response message that includes the intra-coded frame data, so that the terminal plays the intra-coded frame data.

In still another aspect, an embodiment of the present invention provides a terminal, where the terminal includes: an obtaining module, configured to obtain a fast play state of a media file that is based on the Hyper Text Transfer Protocol Live Streaming HLS protocol; a determining module, configured to determine intra-coded frame information corresponding to the fast play state obtained by the obtaining module; a sending module, configured to send a request message to a server, where the request message includes the intra-coded frame information determined by the determining module; a receiving module, configured to receive a response message, which is sent by the server according to the request message sent by the sending module, where the response message includes intra-coded frame data corresponding to the intra-coded frame information; and a playing module, configured to play the intra-coded frame data according to the response message received by the receiving module.

In still another aspect, an embodiment of the present invention provides a server, where the server includes: a receiving module, configured to receive from a terminal a request message that includes intra-coded frame information, where the intra-coded frame information corresponds to a fast play state, which is obtained by the terminal, of a media file that is based on the Hyper Text Transfer Protocol Live Streaming HLS protocol; an obtaining module, configured to obtain intra-coded frame data corresponding to the intra-coded frame information according to the request message received by the receiving module; and a sending module, configured to send to the terminal a response message that includes the intra-coded frame data obtained by the obtaining module, so that the terminal plays the intra-coded frame data.

In still another aspect, an embodiment of the present invention provides a system for playing a media file, where the system includes the terminal and the server according to the embodiments of the present invention.

Based on the foregoing technical solutions, according to the method, the terminal, the server, and the system in the embodiments of the present invention, intra-coded frame data in a fragment of a media file is obtained through interaction between a terminal and a server, so that a terminal supporting HLS can obtain the intra-coded frame data corresponding to a fast play state of the media file and play the data, thereby implementing a fast-forward or rewind function of the media file and improving the quality of user experience.

### BRIEF DESCRIPTION OF DRAWINGS

To illustrate the technical solutions in the embodiments of the present invention more clearly, the following briefly introduces the accompanying drawings required for describing the embodiments of the present invention. Apparently, the accompanying drawings in the following description show merely some embodiments of the present invention, and a person of ordinary skill in the art may still derive other drawings from these accompanying drawings without creative efforts.

FIG. 1 is a schematic flowchart of a method for playing a media file according to an embodiment of the present invention;

FIG. 2 is a schematic flowchart of a method for playing a media file according to another embodiment of the present invention;

FIG. 3 is a schematic flowchart of a method for playing a media file according to still another embodiment of the present invention;

FIG. 4 is a schematic block diagram of a terminal according to an embodiment of the present invention;

FIG. 5 is a schematic block diagram of a server according to an embodiment of the present invention; and

FIG. 6 is a schematic block diagram of a system for playing a media file according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

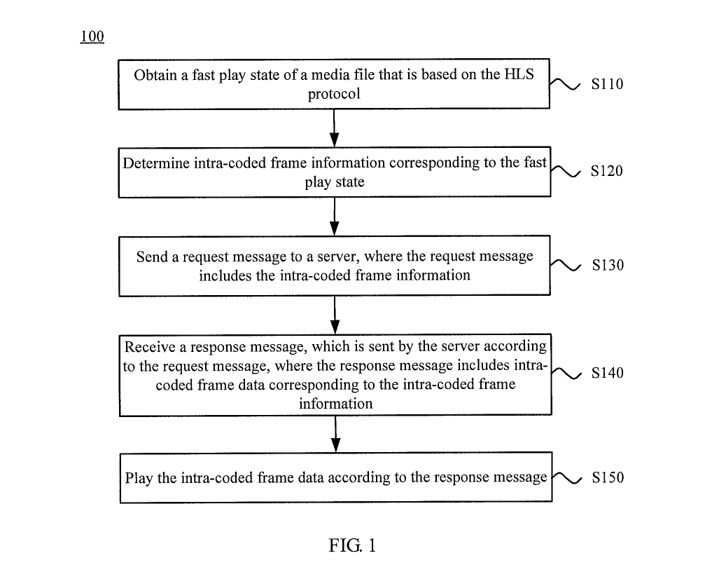

FIG. 1 is a schematic flowchart of a method 100 for playing a media file according to an embodiment of the present invention. As shown in FIG. 1, the method 100 includes the following steps:

S110. Obtain a fast play state of a media file that is based on the Hyper Text Transfer Protocol Live Streaming HLS protocol.

S120. Determine intra-coded frame information corresponding to the fast play state.

S130. Send a request message to a server, where the request message includes the intra-coded frame information.

S140. Receive a response message, which is sent by the server according to the request message, where the response message includes intra-coded frame data corresponding to the intra-coded frame information.

S150. Play the intra-coded frame data according to the response message.

A terminal supporting HLS may determine the intra-coded frame information corresponding to the fast play state according to the obtained fast play state of the media file, and send to the server the request message that includes the intra-coded frame information. In this way, the terminal may receive the response message, which is sent by the server according to the request message, where the response message includes the intra-coded frame data corresponding to the intra-coded frame information, so that the terminal supporting HLS can play the intra-coded frame data according to the response message.

Therefore, according to the method in the embodiment of the present invention, intra-coded frame data in a fragment of a media file is obtained through interaction between a terminal and a server, so that a terminal supporting HLS can obtain the intra-coded frame data corresponding to a fast play state of the media file and play the data, thereby implementing a fast-forward or rewind function of the media file and improving the quality of user experience.

In S110, the terminal obtains the fast play state of the media file that is based on the HLS protocol. Optionally, the fast play state includes a fast-forward state or a rewind state. For example, according to fast-forward or rewind operation information selected by a user, the terminal may determine whether the fast play state of the media file that is based on the HLS protocol is a fast-forward state or a rewind state.

Understandably, the fast-forward state or the rewind state may be used to indicate a specific multiple for fast-forward or rewind. For example, the fast-forward state includes a first fast-forward state, a second fast-forward state, and a third fast-forward state, where the first fast-forward state is used to indicate 2× fast-forward, the second fast-forward state is used to indicate 4× fast-forward, and the third fast-forward state is used to indicate 8× fast-forward.

In S120, the terminal determines the intra-coded frame information, where the intra-coded frame information is used to indicate a position of an intra-coded frame corresponding to the fast play state. Optionally, the determining, by the terminal, intra-coded frame information corresponding to the fast play state includes: determining, by the terminal, the intra-coded frame information according to the fast play state.

Optionally, the intra-coded frame information includes first information indicating a fragment to which the intra-coded frame data belongs, and second information indicating a byte offset of the intra-coded frame data on the fragment. For example, the first information is a name or an identifier of a fragment, and the second information is a specific position of the intra-coded frame data on the fragment.

Understandably, in the embodiment of the present invention, “B corresponding to A” represents that B is correlated with A, and B can be determined according to A. However, further understandably, determining B according to A does not mean that B is determined according to A only, and B may also be determined according to A and/or other information.

Understandably, in the embodiment of the present invention, an intra-coded frame is a result of compressing and encoding a full frame, and the generation or decoding of the intra-coded frame may be independent of other types of frames. For example, the intra-coded frame may be an I frame (I Frame), that is, an internal picture. Further, understandably, a media file that is based on the HLS protocol is generally formed by multiple fragments, where each fragment has multiple code rates, and fragments of each code rate may form an independent transport stream (Transport Stream, “TS” for short) file. Moreover, every time when the terminal downloads a fragment, the terminal may determine to download the fragment of which code rate according to factors such as current network bandwidth and a load of a central processing unit (Central Processing Unit, “CPU” for short), thereby implementing adaptive streaming media playing.

Taking a Moving Picture Experts Group (Moving Pictures Experts Group, “MPEG” for short) video compression technology as an example, a clip of a video file may include multiple TS files, and each TS file may include one or more groups of pictures (Group of Pictures, “GOP” for short). One GOP generally includes three types of frames: I frame, B frame, and P frame. The P frame may be predicted based on the I frame, the B frame may be predicted based on the I frame and the P frame, the P frame may also be called a “forward predictive coded frame”, and the B frame may also be called a “bidirectionally interpolated prediction frame”.

In the embodiment of the present invention, optionally, the terminal determines the intra-coded frame information according to a description file corresponding to the media file and used to describe the media file, where the description file includes byte offsets of all intra-coded frames of each fragment of the media file on a corresponding fragment. Understandably, the byte offset indicates a specific position of the intra-coded frame on the corresponding fragment. That is to say, the terminal may determine the intra-coded frame information according to the fast play state and the description file.

That is to say, in the embodiment of the present invention, the description file corresponding to the media file is extended, so that information about the byte offsets of all the intra-coded frames included in each fragment on the fragment is included before a description about each fragment of the media file in the description file. In this way, the terminal obtains the information about a byte offset of an expected intra-coded frame according to the description file, and further obtains a corresponding intra-coded frame data.

In the embodiment of the present invention, optionally, the description file corresponding to the media file that is based on the HLS protocol is an M3U8 file. Specifically, the M3U8 file of the media file may be described, for example, as:

#EXTM3U
#EXT-X-TARGETDURATION:8
#EXT-X-MEDIA-SEQUENCE:2680
#EXTINF:8, Rangebytes=0-100,500-600,1200-1400
http://priv.example.com/fileSequence2680.ts
#EXTINF:8, Rangebytes=0-130,520-600,1240-1400
http://priv.example.com/fileSequence2681.ts
#EXTINF:8, Rangebytes=0-120,510-600,1220-1400
http://priv.example.com/fileSequence2682.ts.

The M3U8 file describes that one media file includes three TS files, where the TS files are respectively named “fileSequence2680”, “fileSequence2681”, and “fileSequence2682”. The play time of each TS file is 8 seconds. The M3U8 file further describes byte offsets corresponding to intra-coded frames in each TS file and a uniform resource locator (Uniform Resource Locator, “URL” for short) of each TS file.

Taking the TS file named “fileSequence2682” as an example, “Range:bytes=0-120, 510-600, 1220-1400” represents that the TS file includes three intra-coded frames. The byte offset corresponding to the first intra-coded frame is 0-120 bytes (Byte), the byte offset corresponding to the second intra-coded frame is 510-600 bytes, and the byte offset corresponding to the third intra-coded frame is 1220-1400 bytes, and the URL of the TS file is “http://priv.example.com/fileSequence2682.ts”.

For example, in the above example, it is assumed that the user expects to play a media file A that is based on the HLS protocol in a fast-forward manner. Therefore, according to fast-forward operation information selected by the user, the terminal may obtain a fast play state being the second fast-forward state of the media file A, where the second fast-forward state indicates 2× fast-forward playing. According to the second fast-forward state and the M3U8 file used to describe the media file A, for example, by calculating or searching a corresponding mapping table, the terminal may determine that first and third intra-coded frames in the TS file named “fileSequence2680” need to be played. That is to say, the terminal determines that the first information included in the intra-coded frame information corresponding to the fast play state is fileSequence2680, and that the second information included in the intra-coded frame information is Range: 0-100, 1200-1400.

Understandably, in the embodiment of the present invention, the terminal needs to, according to the fast-forward or rewind state, determine the number of an interval of intra-coded frames that are to be played. Generally, provided that the GOP length is constant, if the greater the multiple for fast-forward or rewind selected by the user is, the number of the interval of the intra-coded frames in two played frames that are to be played by the terminal is. Therefore, the terminal can determine the intra-coded frame information. The intra-coded frame information may include relevant information used to obtain data of one intra-coded frame or relevant information used to obtain data of multiple intra-coded frames, and the embodiment of the present invention is not limited thereto.

In S130, the terminal sends to the server the request message including the intra-coded frame information. Optionally, the terminal sends a Hyper Text Transfer Protocol byte range (HTTP Byte range) request message to the server, where the HTTP Byte range request message carries first information indicating a fragment of the an intra-coded frame data that the terminal expects to obtain, and second information indicating a byte offset of the intra-coded frame data on the fragment, that is, the HTTP Byte range request message includes the intra-coded frame information corresponding to the fast play state of the media file.

In S140, the terminal receives the response message, which is sent by the server according to the request message, where the response message includes the intra-coded frame data corresponding to the intra-coded frame information. Optionally, the response message may be an HTTP 200 OK response message. Understandably, the intra-coded frame data may be determined according to the intra-coded frame information.

In S150, the terminal plays the intra-coded frame data according to the response message.

Understandably, when the terminal interacts with the server for one or more times and obtains and plays the intra-coded frame datas corresponding to the fast play state, the fast-forward or rewind function of the media file that is based on the HLS protocol is implemented.

Therefore, according to the method in the embodiment of the present invention, intra-coded frame data in a fragment of a media file is obtained through interaction between a terminal and a server, so that a terminal supporting HLS can obtain the intra-coded frame data corresponding to a fast play state of the media file and play the data, thereby implementing a fast-forward or rewind function of the media file and improving the quality of user experience.

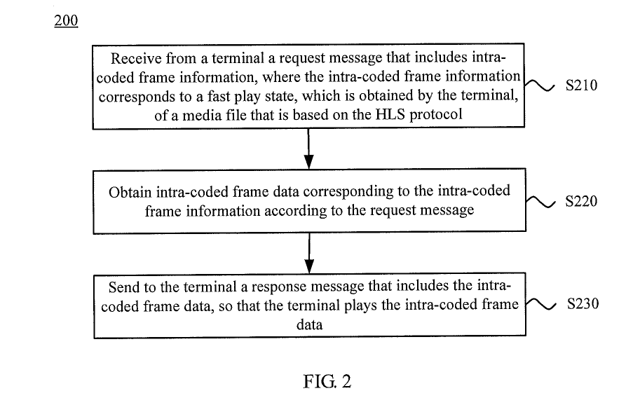

The above has described the method for playing a media file according to the embodiment of the present invention in detail from the perspective of a terminal with reference to FIG. 1, and the following will describe the method according to the embodiment of the present invention from the perspective of a server with reference to FIG. 2.

As shown in FIG. 2, a method 200 for playing a media file according to an embodiment of the present invention includes the following steps:

S210. A server receives from a terminal a request message that includes intra-coded frame information, where the intra-coded frame information corresponds to a fast play state, which is obtained by the terminal, of a media file that is based on the Hyper Text Transfer Protocol Live Streaming HLS protocol.

S220. The server obtains intra-coded frame data corresponding to the intra-coded frame information according to the request message.

S230. The server sends to the terminal a response message that includes the intra-coded frame data, so that the terminal plays the intra-coded frame data.

Understandably, in S210, the intra-coded frame information corresponds to the fast play state, which means that the intra-coded frame information is correlated with the fast play state and the intra-coded frame information can be determined according to the fast play state.

Optionally, the intra-coded frame information is determined by the terminal according to a description file corresponding to the media file, where the description file includes byte offsets of all intra-coded frames of each fragment of the media file on a corresponding fragment. That is to say, the terminal may determine the intra-coded frame information according to the fast play state and the description file.

Optionally, the fast play state includes a fast-forward state or a rewind state. Optionally, the intra-coded frame information includes first information indicating a fragment to which the intra-coded frame data belongs, and second information indicating a byte offset of the intra-coded frame data on the fragment. Optionally, the request message is a Hyper Text Transfer Protocol byte range (HTTP Byte range) request message.

In the embodiment of the present invention, optionally, the intra-coded frame is an I frame. Optionally, the description file corresponding to the media file is an M3U8 file. Further, understandably, the fast-forward state or the rewind state may be used to indicate a specific multiple for fast-forward or rewind.

Therefore, according to the method in the embodiment of the present invention, intra-coded frame data in a fragment of a media file is obtained through interaction between a terminal and a server, so that a terminal supporting HLS can obtain the intra-coded frame data corresponding to a fast play state of the media file and play the data, thereby implementing a fast-forward or rewind function of the media file and improving the quality of user experience.

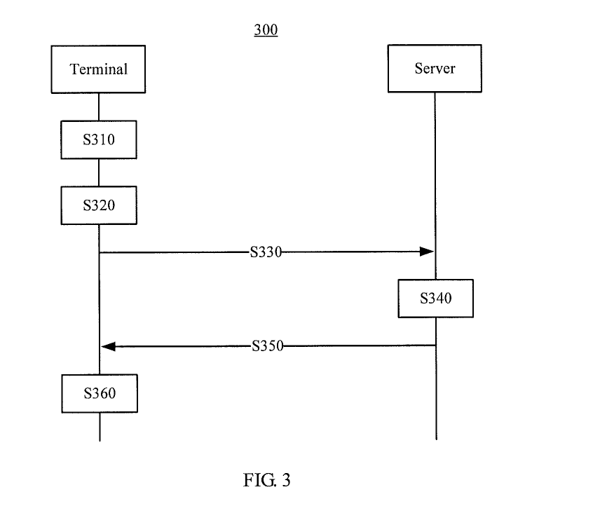

The following describes a method for playing a media file according to an embodiment of the present invention in detail with reference to FIG. 3 through an example where a terminal determines that data of first and third intra-coded frames in a fragment named “fileSequence2681” need to be played to implement a fast-forward or rewind function. As shown in FIG. 3, a method 300 for playing a media file includes the following steps:

S310. A terminal obtains a fast play state of a media file that is based on the HLS protocol, where the fast play state is, for example, a fast-forward state or a rewind state.

S320. The terminal may determine intra-coded frame information corresponding to the fast play state according to a description file corresponding to the media file, where first information included in the intra-coded frame information is fileSequence2681 and second information included in the intra-coded frame information is Range: bytes=0-130, 1240-1400. That is to say, the terminal may determine the intra-coded frame information according to the description file and the fast play state.

S330. The terminal sends an HTTP Byte range request message to a server, where the request message includes the intra-coded frame information.

S340. The server obtains intra-coded frame data corresponding to the intra-coded frame information according to the request message, that is, data of first and third intra-coded frames in a fragment named “fileSequence2681”.

S350. The server sends an HTTP 200 OK response message to the terminal, where the response message includes intra-coded frame data corresponding to the intra-coded frame information.

S360. The terminal plays the data of the first and third intra-coded frames in the fragment named “fileSequence2681” according to the response message, thereby implementing a fast-forward or rewind function.

Understandably, the above is only an example used to describe the embodiment of the present invention, and the embodiment of the present invention is not limited thereto. For example, the terminal may also obtain the data of the first and third intra-coded frames separately.

Further, understandably, in the embodiments of the present invention, the sequence numbers of the above processes do not represent an order of execution, where the orders of execution of the processes may be determined according to their functions and inherent logic, and shall not constitute any limitation on the implementation process of the embodiments of the present invention.

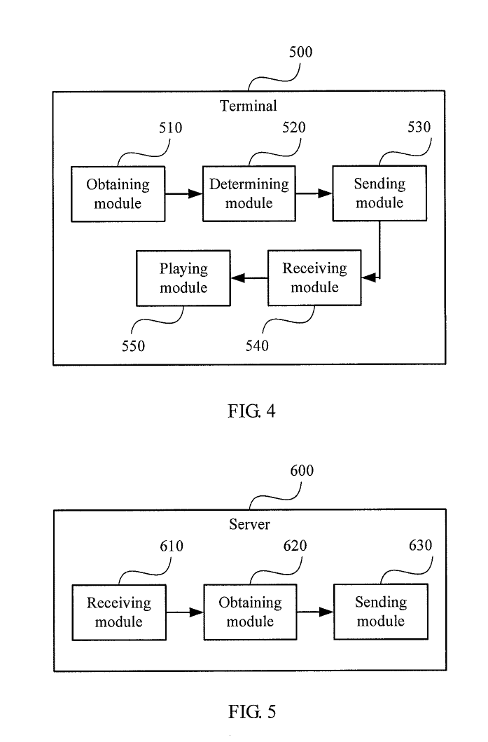

The above has described the method for playing a media file according to the embodiments of the present invention in detail with reference to FIG. 1 to FIG. 3, and the following will describe apparatuses according to embodiments of the present invention in detail with reference to FIG. 4 to FIG. 6. The apparatuses include a terminal, a server, and a system.

FIG. 4 is a schematic block diagram of a terminal 500 according to an embodiment of the present invention. As shown in FIG. 4, the terminal 500 includes:

an obtaining module 510, configured to obtain a fast play state of a media file that is based on the Hyper Text Transfer Protocol Live Streaming HLS protocol;

a determining module 520, configured to determine intra-coded frame information corresponding to the fast play state obtained by the obtaining module 510;

a sending module 530, configured to send a request message to a server, where the request message includes the intra-coded frame information determined by the determining module 520;

a receiving module 540, configured to receive a response message, which is sent by the server according to the request message sent by the sending module 530, where the response message includes intra-coded frame data corresponding to the intra-coded frame information; and

a playing module 550, configured to play the intra-coded frame data according to the response message received by the receiving module 540.

Therefore, according to the terminal in the embodiment of the present invention, intra-coded frame data in a fragment of a media file is obtained through interaction between the terminal and a server, so that a terminal supporting HLS can obtain the intra-coded frame data corresponding to a fast play state of the media file and play the data, thereby implementing a fast-forward or rewind function of the media file and improving the quality of user experience.

In the embodiment of the present invention, optionally, the intra-coded frame information determined by the determining module 520 includes first information indicating a fragment to which the intra-coded frame data belongs, and second information indicating a byte offset of the intra-coded frame data on the fragment.

Optionally, the determining module 520 is further configured to determine the intra-coded frame information according to a description file corresponding to the media file, where the description file includes byte offsets of all intra-coded frames of each fragment of the media file on a corresponding fragment.

Optionally, the fast play state obtained by the obtaining module 510 includes a fast-forward state or a rewind state.

Optionally, the request message sent by the sending module 530 is a Hyper Text Transfer Protocol byte range (HTTP Byte range) request message. Optionally, the response message received by the receiving module 540 is an HTTP 200 OK response message.

Understandably, the terminal 500 according to the embodiment of the present invention may correspond to the terminal in the method for playing a media file in the embodiments of the present invention, and operations and/or functions of the modules in the terminal 500 are intended to respectively implement the corresponding procedures in the methods 100 to 300 in FIG. 1 to FIG. 3, which, for brevity, are not detailed here any further.

Therefore, according to the terminal in the embodiment of the present invention, intra-coded frame data in a fragment of a media file is obtained through interaction between the terminal and a server, so that a terminal supporting HLS can obtain the intra-coded frame data corresponding to a fast play state of the media file and play the data, thereby implementing a fast-forward or rewind function of the media file and improving the quality of user experience.

An embodiment of the present invention further provides a server. As shown in FIG. 5, the server 600 includes:

a receiving module 610, configured to receive from a terminal a request message that includes intra-coded frame information, where the intra-coded frame information corresponds to a fast play state, which is obtained by the terminal, of a media file that is based on the Hyper Text Transfer Protocol Live Streaming HLS protocol;

an obtaining module 620, configured to obtain intra-coded frame data corresponding to the intra-coded frame information according to the request message received by the receiving module 610; and

a sending module 630, configured to send to the terminal a response message that includes the intra-coded frame data obtained by the obtaining module 620, so that the terminal plays the intra-coded frame data.

Optionally, the intra-coded frame information received by the receiving module 610 is determined by the terminal according to a description file corresponding to the media file, where the description file includes byte offsets of all intra-coded frames of each fragment of the media file on a corresponding fragment.

Optionally, the intra-coded frame information received by the receiving module 610 includes first information indicating a fragment to which the intra-coded frame data belongs, and second information indicating a byte offset of the intra-coded frame data on the fragment.

Optionally, the request message received by the receiving module 610 is a Hyper Text Transfer Protocol byte range (HTTP Byte range) request message; and the response message sent by the sending module 630 is an HTTP 200 OK response message.

Understandably, the server 600 according to the embodiment of the present invention may correspond to the server in the method for playing a media file in the embodiments of the present invention, and operations and/or functions of the modules in the server 600 are intended to respectively implement the corresponding procedures in the methods 100 to 300 in FIG. 1 to FIG. 3, which, for brevity, are not detailed here any further.

Therefore, according to the server in the embodiment of the present invention, intra-coded frame data in a fragment of a media file is obtained through interaction between a terminal and the server, so that a terminal supporting HLS can obtain the intra-coded frame data corresponding to a fast play state of the media file and play the data, thereby implementing a fast-forward or rewind function of the media file and improving the quality of user experience.

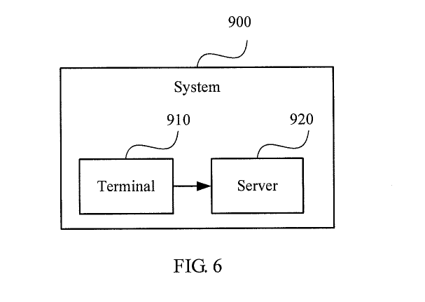

FIG. 6 is a schematic block diagram of a system 900 for playing a media file according to an embodiment of the present invention. As shown in FIG. 6, the system 900 includes:

a terminal 910 according to the embodiment of the present invention; and

a server 920 according to the embodiment of the present invention.

The terminal 910 includes:

an obtaining module, configured to obtain a fast play state of a media file that is based on the Hyper Text Transfer Protocol Live Streaming HLS protocol;

a determining module, configured to determine intra-coded frame information corresponding to the fast play state obtained by the obtaining module;

a sending module, configured to send a request message to the server 920, where the request message includes the intra-coded frame information determined by the determining module;

a receiving module, configured to receive a response message, which is sent by the server 920 according to the request message sent by the sending module, where the response message includes intra-coded frame data corresponding to the intra-coded frame information; and

a playing module, configured to play the intra-coded frame data according to the response message received by the receiving module.

The server 920 includes:

a receiving module, configured to receive from the terminal 910 the request message that includes the intra-coded frame information, where the intra-coded frame information corresponds to the fast play state, which is obtained by the terminal 910, of the media file that is based on the Hyper Text Transfer Protocol Live Streaming HLS protocol;

an obtaining module, configured to obtain the intra-coded frame data corresponding to the intra-coded frame information according to the request message received by the receiving module; and

a sending module, configured to send to the terminal 910 the response message that includes the intra-coded frame data obtained by the obtaining module, so that the terminal 910 plays the intra-coded frame data.

Understandably, the terminal 910 and the server 920 according to the embodiments of the present invention may correspond to the terminal 500 and the server 600 in the embodiments of the present invention respectively, and operations and/or functions of the modules in the terminal 910 and the server 920 are intended to respectively implement the corresponding the procedures in the methods 100 to 300 in FIG. 1 to FIG. 3, which, for brevity, are not detailed here any further.

Therefore, according to the system in the embodiment of the present invention, intra-coded frame data in a fragment of a media file is obtained through interaction between a terminal and a server, so that a terminal supporting HLS can obtain the intra-coded frame data corresponding to a fast play state of the media file and play the data, thereby implementing a fast-forward or rewind function of the media file and improving the quality of user experience.

A person of ordinary skill in the art may appreciate that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It can be clearly understood by a person skilled in the art that, for the purpose of convenient and brief description, for a detailed working process of the foregoing system, apparatus and unit, reference may be made to the corresponding process in the method embodiments, and the details will not be described herein again.

In the several embodiments provided in the present application, it should be understood that, the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, and may be located in one position, or may be distributed on a plurality of network units. A part or all of the units herein may be selected according to the actual needs to achieve the objectives of the solutions of the embodiments of the present invention.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit are implemented in a form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in a form of a software product. The computer software product is stored in a storage medium and includes several instructions for instructing a computer device (which may be a personal computer, a server, a network device, or the like) to perform all or a part of the steps of the methods described in the embodiments of the present invention. The foregoing storage medium includes: any medium that can store program codes, such as a USB flash disk, a removable hard disk, a read-only memory (ROM, Read-Only Memory), a random access memory (RAM, Random Access Memory), a magnetic disk, or an optical disk.

The foregoing descriptions are merely specific embodiments of the present invention, but are not intended to limit the protection scope of the present invention. Any equivalent modification or replacement readily figured out by a person skilled in the art within the technical scope disclosed in the present invention shall fall within the protection scope of the present invention. Therefore, the protection scope of the present invention shall be subject to the protection scope of the claims.

1. A method for playing a media file, comprising:
obtaining a fast play state of a media file that is based on the Hyper Text Transfer Protocol Live Streaming HLS protocol;
determining intra-coded frame information corresponding to the fast play state;
sending a request message to a server, wherein the request message comprises the intra-coded frame information;
receiving a response message, which is sent by the server according to the request message, wherein the response message comprises intra-coded frame data corresponding to the intra-coded frame information; and
playing the intra-coded frame data according to the response message.

2. The method according to claim 1, wherein the determining intra-coded frame information corresponding to the fast play state comprises:
determining the intra-coded frame information according to a description file corresponding to the media file, wherein the description file comprises byte offsets of all intra-coded frames of each fragment of the media file on a corresponding fragment.

3. The method according to claim 1, wherein the intra-coded frame information comprises first information indicating a fragment to which the intra-coded frame data belongs, and second information indicating a byte offset of the intra-coded frame data on the fragment.

4. The method according to claim 1, wherein the fast play state comprises a fast-forward state or a rewind state.

5. The method according to claim 1, wherein the request message is a Hyper Text Transfer Protocol byte range (HTTP Byte range) request message.

6. A method for playing a media file, comprising:
receiving from a terminal a request message that comprises intra-coded frame information, wherein the intra-coded frame information corresponds to a fast play state, which is obtained by the terminal, of a media file that is based on the Hyper Text Transfer Protocol Live Streaming HLS protocol;
obtaining intra-coded frame data corresponding to the intra-coded frame information according to the request message; and
sending to the terminal a response message that comprises the intra-coded frame data, so that the terminal plays the intra-coded frame data.

7. The method according to claim 6, wherein the intra-coded frame information is determined by the terminal according to a description file corresponding to the media file, wherein the description file comprises byte offsets of all intra-coded frames of each fragment of the media file on a corresponding fragment.

8. The method according to claim 6, wherein the intra-coded frame information comprises first information indicating a fragment to which the intra-coded frame data belongs, and second information indicating a byte offset of the intra-coded frame data on the fragment.

9. The method according to claim 6, wherein the request message is a Hyper Text Transfer Protocol byte range (HTTP Byte range) request message.

10. A terminal, comprising:
an obtaining module, configured to obtain a fast play state of a media file that is based on the Hyper Text Transfer Protocol Live Streaming HLS protocol;
a determining module, configured to determine intra-coded frame information corresponding to the fast play state obtained by the obtaining module;
a sending module, configured to send a request message to a server, wherein the request message comprises the intra-coded frame information determined by the determining module;
a receiving module, configured to receive a response message, which is sent by the server according to the request message sent by the sending module, wherein the response message comprises intra-coded frame data corresponding to the intra-coded frame information; and
a playing module, configured to play the intra-coded frame data according to the response message received by the receiving module.

11. The terminal according to claim 10, wherein the determining module is further configured to determine the intra-coded frame information according to a description file corresponding to the media file, wherein the description file comprises byte offsets of all intra-coded frames of each fragment of the media file on a corresponding fragment.

12. The terminal according to claim 10, wherein the intra-coded frame information determined by the determining module comprises first information indicating a fragment to which the intra-coded frame data belongs, and second information indicating a byte offset of the intra-coded frame data on the fragment.

13. The terminal according to claim 10, wherein the fast play state obtained by the obtaining module comprises a fast-forward state or a rewind state.

14. The terminal according to claim 10, wherein the request message sent by the sending module is a Hyper Text Transfer Protocol byte range (HTTP Byte range) request message.

15. A server, comprising:
a receiving module, configured to receive from a terminal a request message that comprises intra-coded frame information, wherein the intra-coded frame information corresponds to a fast play state, which is obtained by the terminal, of a media file that is based on the Hyper Text Transfer Protocol Live Streaming HLS protocol;
an obtaining module, configured to obtain intra-coded frame data corresponding to the intra-coded frame information according to the request message received by the receiving module; and
a sending module, configured to send to the terminal a response message that comprises the intra-coded frame data obtained by the obtaining module, so that the terminal plays the intra-coded frame data.

16. The server according to claim 15, wherein the intra-coded frame information received by the receiving module is determined by the terminal according to a description file corresponding to the media file, wherein the description file comprises byte offsets of all intra-coded frames of each fragment of the media file on a corresponding fragment.

17. The server according to claim 15, wherein the intra-coded frame information received by the receiving module comprises first information indicating a fragment to which the intra-coded frame data belongs, and second information indicating a byte offset of the intra-coded frame data on the fragment.

18. The server according to claim 15, wherein the request message received by the receiving module is a Hyper Text Transfer Protocol byte range (HTTP Byte range) request message.

19. A system comprising:
a terminal configured to obtain a fast play state of a media file that is based on the Hyper Text Transfer Protocol Live Streaming HLS protocol, to determine intra-coded frame information corresponding to the obtained fast play state, to send a request message to a server, wherein the request message comprises the determined intra-coded frame information, to receive a response message, which is sent by the server according to the sent request message, wherein the response message comprises intra-coded frame data corresponding to the intra-coded frame information, and to play the intra-coded frame data according to the received response message.

20. A system comprising:
a server configured to receive from a terminal a request message that comprises intra-coded frame information, wherein the intra-coded frame information corresponds to a fast play state, which is obtained by the terminal, of a media file that is based on the Hyper Text Transfer Protocol Live Streaming HLS protocol, to obtain intra-coded frame data corresponding to the intra-coded frame information according to the received request message, and to send to the terminal a response message that comprises the obtained intra-coded frame data, so that the terminal plays the intra-coded frame data.
